(19) United States
(12) Patent Application Publication
(10) Pub. No.: US 2020/0402500 A1
(43) Pub. Date: Dec. 24, 2020

(54) METHOD AND DEVICE FOR GENERATING SPEECH RECOGNITION MODEL AND STORAGE MEDIUM

(71) Applicant: Beijing Dajia Internet Information Technology Co., Ltd., Beijing (CN)

(72) Inventors: Yuanyuan Zhao, Beijing (CN); Jie Li, Beijing (CN); Xiaorui Wang, Beijing (CN); Yan Li, Beijing (CN)

(21) Appl. No.: 17/011,809

(22) Filed: Sep. 3, 2020

(30) Foreign Application Priority Data
Sep. 6, 2019 (CN) 201910840757.4

(51) Int. Cl. G10L 15/06; G10L 15/02

(52) U.S. Cl. CPC G10L 15/063; G10L 15/02

(57) ABSTRACT

A method and device for generating speech recognition model are provided. The method includes: obtaining training samples, wherein each training sample includes a speech frame sequence and a labeled text sequence; training the encoder by using the speech frame sequence as an input feature and using speech encoded frames of the speech frame sequence as an output feature; training the decoder by using the speech encoded frames as a first input feature and using the labeled text sequence as a first output feature, and obtaining a current prediction text sequence; and training the decoder again by using the speech encoded frames as a second input feature and using a sequence as a second output feature, wherein the sequence is obtained by sampling the labeled text sequence and the current prediction text sequence based on a preset probability.

### CROSS REFERENCE TO RELATED APPLICATIONS

This application is based on and claim priority under 35 U.S.C. 119 to Chinese Patent application No. 201910840757.4, filed on Sep. 6, 2019, in the China National Intellectual Property Administration, the disclosures of which is herein incorporated by reference in its entirety.

### FIELD

The disclosure relates to the field of speech recognition technology, and particularly to a method and device for generating a speech recognition model and a storage medium.

### BACKGROUND

At present, the mainstream speech recognition framework is an end-to-end framework based on a codec attention mechanism. However, the end-to-end framework is high in computational resource consumption, and difficult in parallel computing. Moreover, the end-to-end framework may accumulate last moment errors to cause lower recognition accuracy and poorer recognition results.

### SUMMARY

According to a first aspect of an embodiment of the disclosure, a method for generating a speech recognition model is provided. The method includes: obtaining training samples, wherein each of the training samples includes a speech frame sequence and a corresponding labeled text sequence; training the encoder by using the speech frame sequence as an input feature of the encoder and using speech encoded frames of the speech frame sequence as an output feature of the encoder; and training the decoder by using the speech encoded frame as a first input feature of the decoder and using the labeled text sequence as a first output feature of the decoder, and obtaining a current prediction text sequence; and training the decoder again by using the speech encoded frame as a second input feature of the decoder and using a sequence as a second output feature of the decoder, wherein the sequence is obtained by sampling the labeled text sequence and the current prediction text sequence based on a preset probability.

According to an embodiment of the disclosure, said obtaining training samples includes: obtaining a speech signal; obtaining an initial speech frame sequence by extracting a speech feature from the speech signal; and obtaining spliced speech frames by splicing speech frames in the initial speech frame sequence; and obtaining the speech frame sequence by down-sampling the spliced speech frames.

According to an embodiment of the disclosure, the preset probability is determined based on an accuracy of the current prediction text sequence output by the decoder.

According to an embodiment of the disclosure, the preset probability is determined by: determining the preset probability of sampling the current prediction text sequence based on a direct proportion to the accuracy of the current prediction text sequence, and determining the preset probability of sampling the labeled text sequence based on an inverse proportion to the accuracy of the current prediction text sequence.

According to an embodiment of the disclosure, the method further includes: terminating training the speech recognition model in response to that a proximity between the current prediction text sequence and the labeled text sequence satisfies a preset value, and that a character error rate (CER) in the current prediction text sequence satisfies a preset value, wherein the labeled text sequence corresponds to the current prediction text sequence.

According to an embodiment of the disclosure, the labeled text sequence is the labeled syllable sequence, and the prediction text sequence is a prediction syllable sequence.

According to a second aspect of an embodiment of the disclosure, a device for generating a speech recognition model is provided, where the speech recognition model includes an encoder and a decoder. The device includes: a processor; and a memory configured to store instructions executable by the processor; wherein the processor is configured to execute the instructions to: obtain training samples, wherein each of the training sample comprises a speech frame sequence and a corresponding labeled text sequence; train the encoder by using the speech frame sequence as an input feature of the encoder and using speech encoded frames of the speech frame sequence as an output feature of the encoder; and train the decoder by using the speech encoded frames as a first input feature of the decoder and using the labeled text sequence as a first output feature of the decoder, and obtain a current prediction text sequence; train the decoder again by using the speech encoded frame as a second input feature of the decoder and using a sequence as a second output feature of the decoder, wherein the sequence is obtained by sampling the labeled text sequence and the current prediction text sequence based on a preset probability.

According to an embodiment of the disclosure, the processor configured to: obtain a speech signal; obtain an initial speech frame sequence by extracting speech features from the speech signal; obtain spliced speech frame by splicing speech frames in the initial speech frame sequence, and obtain the speech frame sequence by down-sampling the spliced speech frames.

According to an embodiment of the disclosure, the preset probability is determined based on an accuracy of the current prediction text sequence output by the decoder.

According to an embodiment of the disclosure, the processor is configured to: determine the preset probability of sampling the current prediction text sequence in a direct proportion to the accuracy of the current prediction text sequence output by the decoder, and determine the preset probability of sampling the labeled text sequence in an inverse proportion to the accuracy of the current prediction text sequence output by the decoder.

According to an embodiment of the disclosure, the processor is further configured to: terminate training the speech recognition model in response to that a proximity between the current prediction text sequence and the labeled text sequence satisfies a preset value and that a character error rate (CER) in the current prediction text sequence satisfies a preset value, wherein the labeled text sequence corresponds to the current prediction text sequence.

According to an embodiment of the disclosure, the labeled text sequence is the labeled syllable sequence, and the prediction text sequence is a predicted syllable sequence.

According to a third aspect of an embodiment of the disclosure, a computer readable storage medium is provided. The computer readable storage medium stores computer programs that, when executed by a processor, cause the processor to perform the operation of: obtaining training samples, wherein each of the training samples comprises a speech frame sequence and a corresponding labeled text sequence; training an encoder by using the speech frame sequence as an input feature of the encoder and using speech encoded frames of the speech frame sequence as an output feature of the encoder; training a decoder by using the speech encoded frames as a first input feature of the decoder and using the labeled text sequence as a first output feature of the decoder, and obtaining a current prediction text sequence; and training the decoder again by using the speech encoded frames as a second input feature of the decoder and using a sequence as a second output feature of the decoder, wherein the sequence is obtained by sampling the labeled text sequence and the current prediction text sequence based on a preset probability.

### BRIEF DESCRIPTION OF THE DRAWINGS

FIG. 1 is a schematic diagram of a speech recognition model according to an embodiment of the disclosure;

FIG. 2 is a schematic diagram of a speech recognition model according to an embodiment of the disclosure;

FIG. 3 is flow chart of a method for generating a speech recognition model according to an embodiment of the disclosure;

FIG. 4 is a schematic diagram of a device for generating a speech recognition model according to an embodiment of the disclosure; and

FIG. 5 is a schematic diagram of electronic equipment according to an embodiment of the disclosure.

### DETAILED DESCRIPTION

In order to make the objects, technical solutions, and advantages of the disclosure clearer, the disclosure will be described in detail below in combination with accompanying drawings. Apparently, the described embodiments are only a part but not all of the embodiments of the disclosure. Based upon the embodiments of the disclosure, all of the other embodiments obtained by those skilled in the art without any creative effort shall all fall within the scope of the disclosure.

### Embodiment 1

In the related art, the speech is recognized by end-to-end framework based on a codec attention mechanism, the following shortcomings still exist. On one hand, the encoded and decoding functions in the current speech recognition neural network model are both realized based on the recurrent neural network, while the recurrent neural network has such problems as high computational resource consumption, and difficult parallel computing. On the other hand, when the current speech recognition neural network model is trained, the labeled text data corresponding to the input speech frame can ensure that the output at the previous moment is correct, therefore when output mistakes at the previous moment are not considered in the process of training, and when the model after training is used for speech recognition, the output mistake at the previous moment will lead to accumulation of mistakes therefore, the model has low recognition accuracy and poor recognition effect.

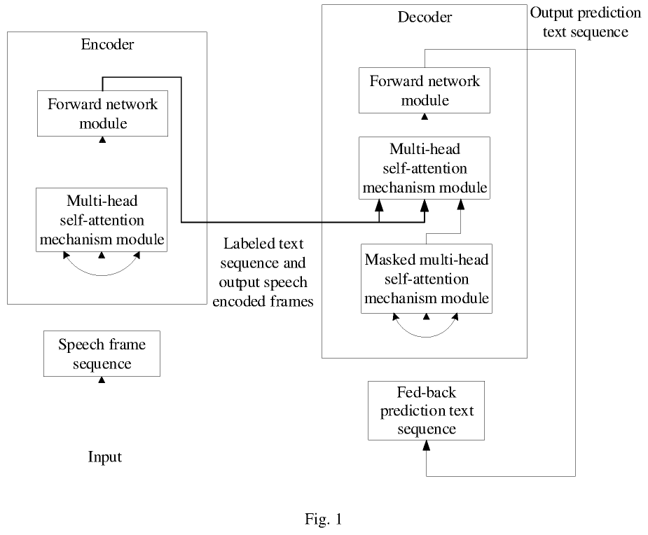

The current proposed end-to-end speech recognition model is as shown in FIG. 1, and the model includes an encoder 100 and a decoder 101.

The encoder 100 includes multiple blocks, and each block includes a multi-head self-attention mechanism module and a forward network module, and the encoder 100 is configured to encode the input speech sequence.

The decoder 101 includes multiple blocks, and each block includes a multi-head self-attention mechanism module, a masked multi-head self-attention mechanism module and a forward network module. The input end of the decoder includes: a speech encoded frame after encoded, a prediction text sequence fed back by the output end of the decoder, and a labeled text sequence.

In the process of training the above model, the prediction text sequence output by the output end at the previous moment can be ensured to be accurate according to the labeled text sequence, therefore in the process of model training, the wrong output prediction text is not considered to be taken as a reference factor of training. Thus when the well-trained model is used for speech recognition, and when the prediction text sequence of the previous moment is wrong, mistakes will be accumulated.

To solve the above technical problem, the disclosure provides a method for generating a speech recognition model. The model is an encoder-decoder model based on a self-attention mechanism and is an end-to-end model without a recurrent neural network structure. The model mainly adopts a self-attention mechanism to encode and decode the speech frame in combination with a forward network.

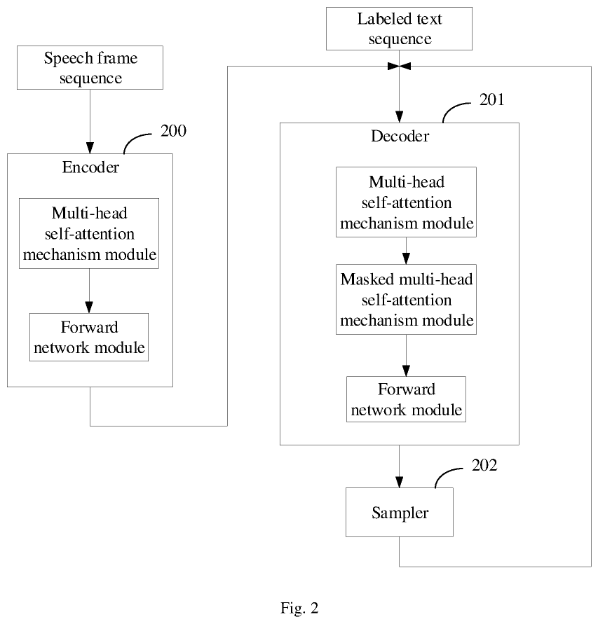

The disclosure provides a speech recognition model, as shown in FIG. 2, the model includes: an encoder 200, a decoder 201, and a sampler 202. The encoder 200 is configured to model feature frames of speech, and obtain high-level information representation of acoustics. The decoder is configured to model language information, and predict the output at the current moment based on the output at the last moment and the information representation of acoustics; and the sampler is configured to sample data, text sequence, and the like. Each component (for example the encoder, decoder or the sampler) in the model can be a virtual module, and the function of the virtual module can be realized through computer programs.

The encoder 200 includes multiple blocks, and each block includes a multi-head self-attention mechanism module and a forward network module. Since speech includes multiple characteristics, for example, speed and volume of speech, type of localism, and background noise, therefore, one-head of the multi-head self-attention mechanism module is configured to calculate one of the characteristics of speech, and the forward network module can determine the output dimension d of the encoder.

The decoder 201 includes multiple blocks, each block includes a multi-head self-attention mechanism module, a masked multi-head self-attention mechanism module and a forward network module, one multi-head self-attention mechanism module is configured to calculate the similarity between the speech frame sequence and the corresponding labeled text sequence, to obtain a first prediction text sequence, one masked multi-head self-attention mechanism module is configured to calculate the correlation between the first prediction text sequence and the previous prediction text sequence, and select the current prediction text sequence from the first prediction text, and the forward network module can determine the output dimension d of the encoder.

The sampler 202 is configured to sample based on a preset probability an labeled text sequence corresponding to the speech frame sequence and a prediction text sequence fed back by an output end of the encoder-decoder model.

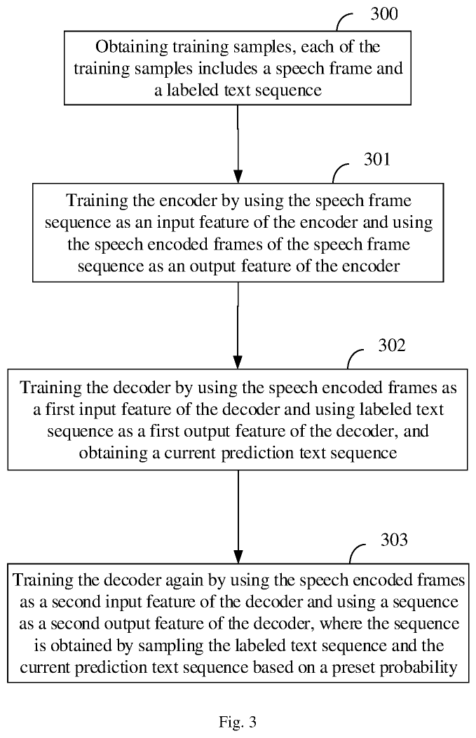

On the basis of the above encoder-decoder model, the disclosure provides a method for generating a speech recognition model. The speech recognition model includes an encoder and a decoder. The method of the embodiment of the disclosure can be performed by an electronic equipment, and the electronic equipment can be a computer, a server, a smart phone, or a processor, etc. As shown in FIG. 3, the implementing flow includes the following steps.

Step 300: obtaining training samples, wherein each training sample includes a speech frame sequence and a corresponding labeled text sequence.

In some embodiments, the training samples can be obtained by the following manner.

1) obtaining a speech signal; and obtaining an initial speech frame sequence by extracting speech features from the speech signal.

A speech feature extraction module can be utilized to extract features, for example, the speech feature extraction module can be utilized to extract Mel-scale frequency cepstral coefficients (MFCC) feature of speech signal. In some embodiments, the speech feature extraction module can be adopted to extract MFCC feature of 40 dimensions.

2) obtaining spliced speech frames by splicing the speech frames in the initial speech frame sequence, and obtaining the speech frame sequence by down-sampling the spliced speech frames.

In some embodiments, the initial speech frame sequence can be normalized by cepstral mean and variance normalization (CMVN), and then the speech frames in the initial speech frame sequence are spliced, and several speech frames are spliced as a new speech frame, and finally the new speech frames are down-sampled after frame splicing, to lower the frame rate of the speech frame. For example, six speech frames can be spliced as a new speech frame, and after down-sampling, the frame rate of the multiple new speech frames is 16.7 Hz.

In the embodiment, when the speech frame sequence is processed at a lower frame rate, the length of the speech frame sequence can be reduced to one sixth of the original length, and the calculated amount is reduced by about 36 times.

Step 301: training the encoder by using the speech frame sequence as an input feature of the encoder and using the speech encoded frames of the speech frame sequence as an output feature of the encoder.

Step 302: training the decoder by using the speech encoded frames as a first input feature of the decoder and using the labeled text sequence as a first output feature of the decoder, and obtaining a current prediction text sequence; wherein the labeled text sequence corresponds to the speech frame sequence as the input feature of the encoder.

Step 303: training the decoder again by using the speech encoded frames as a second input feature of the decoder and using a sequence as a second output feature of the decoder, wherein the sequence is obtained by sampling the labeled text sequence and the current prediction text sequence based on a preset probability.

The speech recognition model is trained by using the training samples. In the training process, the similarity between any speech frame in the speech frame sequence and each of the following speech frames is calculated by an encoder in the speech recognition model, to obtain speech encoded frames; after then sampling the labeled text sequence corresponding to the speech frame sequence and the prediction text sequence output by an output end of the decoder based on a preset probability, a previous prediction text sequence is obtained in combination with the labeled text sequence, the speech encoded frame is decoded according to the labeled text sequence and the previous prediction text sequence, and the current prediction text sequence is output at the output end.

In order to clearly describe the above training process, the process for training the encoder or training the decoder will be respectively illustrated.

In the first part, the encoder in the speech recognition model is trained, the speech frame sequence is used as an input feature of the encoder, the speech encoded frames of the speech frame sequence are used as an output feature of the encoder, to train the encoder.

In the training process, the similarity between any speech frame in the speech frame sequence and each of the following speech frames is calculated by using an encoder. Since the encoder does not include a recurrent neural network, but is an encoder based on a self-attention mechanism, the similarity between any two arbitrary frames in the speech frame sequence is calculated, thereby ensuring that the calculating process has a long-time dependence compared with the recurrent neural network. The precedence relationship between each syllable and another syllable in the speech signal is considered, thereby ensuring stronger correlation.

In the second part, the decoder in the speech recognition model is trained, the speech encoded frames output by the encoder are used as a first input feature of the decoder, and the labeled text sequence corresponding to the speech frame sequence is used as a first output feature of the decoder to train the decoder, and the current prediction text sequence is obtained. However, the current prediction text sequence is merely predicted by the labeled text, and further, in the present embodiment, the speech encoded frames are used as a second input feature of the decoder, and the sequence, which is obtained by sampling the labeled text sequence and the current prediction text sequence based on a preset probability, is used as a second output feature of the decoder, to train the decoder again.

In some embodiments, the sampler samples the labeled text sequence and the current prediction text sequence based on a preset probability and input into the decoder. The process is as follows.

The decoder includes three input ends, one input end is for the input of the speech encoded frame, the other input end is for input of the labeled text sequence, and the last input end is for input of the prediction text sequence fed back by the decoder output end. The labeled text sequence and the fed-back prediction text sequence (that is, the current prediction text sequence output by the decoder) are firstly sampled based on a preset probability and then input into a decoder for decoding.

In some embodiments, decoding steps of the decoder are as follows.

1) Selecting a text, with the similarity between the text and the speech encoded frame being greater than a preset value, in the labeled text sequence, to obtain a first prediction text sequence.

The similarity between the speech encoded frame and the labeled text sequence can be calculated based on a self-attention mechanism, to select the labeled text sequence, to obtain the first prediction text sequence.

2) Calculating the correlation between the first prediction text sequence and the previous prediction text sequence, to select the current prediction text sequence from the first prediction text.

The correlation between the first prediction text sequence and the previous prediction text sequence can be calculated based on the self-attention mechanism, to screen the currently predicted text sequence.

In the present embodiment, in the decoding process, the labeled text sequence and the output current prediction text sequence are not directly adopted, but the labeled text sequence corresponding to the speech frame sequence and the current prediction text sequence output by the decoder are sampled based on a preset probability and then input to the decoder to train the decoder again. With sampling, the wrong prediction text in the prediction text sequence combined with the correct labeled text are input into the decoder for training, to reduce the influence of mistake accumulation on the model in the training process.

In some embodiments, a sampling algorithm of scheduled sampling (SS) can also be adopted in the present embodiment, the labeled text sequence corresponding to the speech frame sequence and the current prediction text sequence output by the decoder are scheduled sampled based on the preset probability, such that the training process and the predicting process of the model can be more matched, thereby effectively alleviating error accumulation caused by the mistake of the output prediction text of the previous moment.

In some embodiments, the preset probability is determined based on the accuracy of the current prediction text sequence output by the decoder. For example, if the accuracy of the prediction text sequence is relatively low, the sampling probability of the prediction text sequence is relatively low, and the sampling probability of the labeled text sequence is relatively large, thereby ensuring that not too many wrong prediction texts will be introduced in the training process, and still ensuring that the model outputs correct prediction results.

In some embodiments, the preset probability of sampling the prediction text sequence is determined in a direct proportion to the accuracy of the prediction text sequence, and the preset probability of sampling the labeled text sequence is determined in an inverse proportion to the accuracy of the prediction text sequence. For example, when the accuracy of the prediction text sequence is lower than 10%, sampling is performed between the labeled text sequence corresponding to the speech frame sequence and the current prediction text sequence output by the decoder based on a sampling probability of 90%. Given that the number of texts in the labeled text sequence and the current prediction text sequence is 100, then when sampling is based on a sampling probability of 90%, 90 texts are selected from the labeled text sequence, and 10 texts are selected from the current prediction text sequence, and the selected texts are input into an encoder model for decoding. When the accuracy of the prediction text sequence is high than 90%, sampling is performed between the labeled text sequence corresponding to the speech frame sequence and the prediction text sequence output by the decoder according to a sampling probability of 10%. Given that the number of texts in the labeled text sequence and the current prediction text sequence is 100, then when sampling is based on a sampling probability of 10%, 10 texts are selected from the labeled text sequence, and 90 texts are selected from the current prediction text sequence, and the selected texts are input into an encoder model for decoding.

In the present embodiment, based on a change in accuracy of the output prediction text from small to large, an adaptive adjustment mechanism can be adopted to sample the prediction text sequence based on a preset probability from small to large, for example, when the accuracy of the prediction text sequence is gradually increased from 0% to 90%, the sampling of the prediction text sequence is in a sampling probability of gradually increasing from 0% to 90%. Meanwhile, the sampling of the labeled text sequence is in a sampling probability of gradually decreasing from 100% to 10%.

In some embodiments, the training of the speech recognition model is terminated in response to that the proximity between the current prediction text sequence and the corresponding labeled text sequence satisfies a preset value, and when the character error rate (CER) in the current prediction text sequence satisfies a preset value.

In some embodiments, a cross entropy can be used as a target function to train the above model to converge, and the proximity between the current prediction text sequence and the labeled text sequence is determined to satisfy a preset value through the observed loss value. Since although the loss value observed by using a cross entropy is strongly correlated with the error rate of the word or phrase in the finally output prediction text sequence, however, the error rate of words are not directly modeled, therefore, in some embodiments of the disclosure, the minimum word error rate (MWER) criterion is also used as a fine-tune network of the target function to further train the model. The training is terminated in response to that the character error rate (CER) in the current prediction text sequence satisfies a preset value. The MWER criterion has the advantage of directly utilizing the character error rate (CER) to optimize the evaluation criterion of the above model, so as to be directly used as a constraint condition of terminating model training based on the character error rate, and effectively improve model performance.

In some embodiments, a modeling unit is a syllable, the labeled text sequence is the labeled syllable sequence, and the prediction text sequence is the predicted syllable sequence. Compared with Chinese characters which serve as an output prediction text sequence, the syllables have an advantage of fixed number, the modeling granularity is the same as Chinese characters, the problem of insufficient vocabulary will not exist, when a language model is added, the performance gains are far greater than those of Chinese characters.

### Embodiment 2

In some embodiments, the disclosure further provides a device for generating a speech recognition model. Since the device is just the device in the method according to the embodiments of the disclosure, and the principle based on which the device solves problems is similar to the principle in the method, therefore, for the implementation of the device, please refer to the implementation of the method, and the repeated parts will not be omitted.

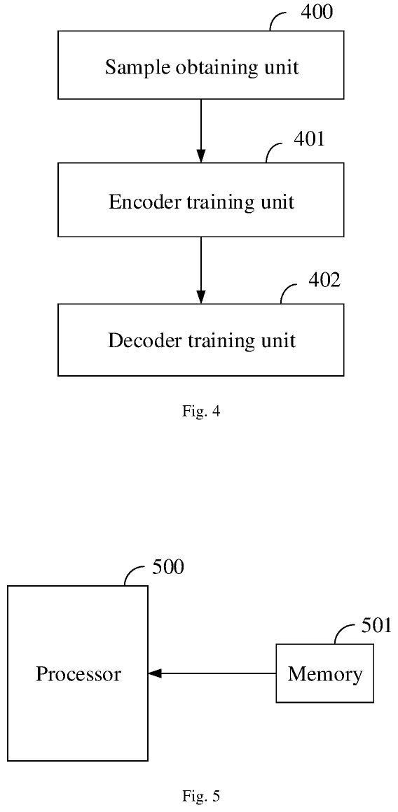

As shown in FIG. 4, the speech recognition model includes an encoder and a decoder, and the device includes: a sample obtaining unit 400, an encoder training unit 401 and a decoder training unit 402.

The sample obtaining unit 400 is configured to obtain training samples, wherein each of the training samples includes a speech frame sequence and a corresponding labeled text sequence.

The encoder training unit 401 is configured to train the encoder by using the speech frame sequence as an input feature of the encoder and using the speech encoded frames of the speech frame sequence as an output feature of the encoder.

The decoder training unit 402 is configured to train the decoder by using the speech encoded frames as a first input feature of the decoder and using the labeled text sequence corresponding to the speech frame sequence as a first output feature of the decoder, and obtain a current prediction text sequence; train the decoder again by using the speech encoded frame as a second input feature of the decoder and use a sequence as a second output feature, the sequence is obtained by sampling the labeled text sequence and the current prediction text sequence.

In some embodiments, the sample obtaining unit 400 is configured to: obtain a speech signal; obtain an initial speech frame sequence by extracting speech features from the speech signal; obtain spliced speech frames by splicing speech frames in the initial speech frame sequence; and obtain the speech frame sequence by down-sampling the spliced speech frames.

In some embodiments, the preset probability is determined based on an accuracy of the prediction text sequence output by the decoder.

In some embodiments, the decoder training unit 402 is configured to: determine the preset probability of sampling the current prediction text sequence in a direct proportion to the accuracy of the current prediction text sequence output by the decoder, and determine the preset probability of sampling the labeled text sequence in an inverse proportion to the accuracy of the current prediction text sequence output by the decoder.

In some embodiments, the device further includes a training terminate unit which is configured to: terminate training the speech recognition model in response to that a proximity between the current prediction text sequence and the corresponding labeled text sequence satisfies a preset value and that a character error rate (CER) in the current prediction text sequence satisfies a preset value.

In some embodiments, the labeled text sequence is the labeled syllable sequence, and the prediction text sequence is a predicted syllable sequence.

### Embodiment 3

In some embodiments, the disclosure further provides electronic equipment. Since the electronic equipment is just the electronic equipment in the method according to the embodiments of the disclosure, and the principle based on which the electronic equipment solves problems is similar to the principle in the method, therefore, for the implementation of the electronic equipment, please refer to the implementation of the method, and the repeated parts will be omitted herein.

As shown in FIG. 5, the electronic equipment includes: a processor 500; and a memory 501 configured to store instructions executable by the processor 500. The processor 500 is configured to execute the instructions to: obtain training samples, wherein each of the training samples includes a speech frame sequence and a corresponding labeled text sequence; train the encoder by using the speech frame sequence as an input feature of the encoder and using the speech encoded frames of the speech frame sequence as an output feature of the encoder; and train the decoder by using the speech encoded frames as a first input feature of the decoder and using the labeled text sequence as a first output feature of the decoder, and obtain a current prediction text sequence; train the decoder again by using the speech encoded frames as a second input feature of the decoder and using the sequence as a second output feature of the decoder, wherein the sequence is obtained by sampling the labeled text sequence and the current prediction text sequence based on a preset probability.

In some embodiments, the processor 500 is configured to: obtain a speech signal; obtain an initial speech frame sequence by extracting speech features from the speech signal; obtain spliced speech frames by splicing speech frames in the initial speech frame sequence; and obtain the speech frame sequence by down-sampling the spliced speech frames.

In some embodiments, the preset probability is determined based on the accuracy of the prediction text sequence output by the decoder.

In some embodiments, the processor 500 is configured to: determine the preset probability of sampling the current prediction text sequence in a direct proportion to the accuracy of the current prediction text sequence output by the decoder, and determine the preset probability of sampling the labeled text sequence in an inverse proportion to the accuracy of the current prediction text sequence output by the decoder.

In some embodiments, the processor 500 is further configured to: terminate training the speech recognition model in response to that a proximity between the current prediction text sequence and the labeled text sequence satisfies a preset value and that a character error rate (CER) in the current prediction text sequence satisfies a preset value.

In some embodiments, the labeled text sequence is the labeled syllable sequence, and the prediction text sequence is a predicted syllable sequence.

The present embodiment further provides a computer storage medium storing computer programs that, when executed by a processor, cause the processor to perform the operation of: obtaining training samples, wherein each of the training samples includes a speech frame sequence and a corresponding labeled text sequence; training an encoder by using the speech frame sequence as an input feature of the encoder and using speech encoded frames of the speech frame sequence as an output feature of the encoder; training the decoder again by using the speech encoded frames as a second feature of the decoder and using a sequence as a second output feature of the decoder, wherein the sequence is obtained by sampling the labeled text sequence and the current prediction text sequence based on a preset probability.

It should be understood by those skilled in the art that the embodiments of the disclosure can provide methods, systems and computer program products. Thus the disclosure can take the form of hardware embodiments alone, software embodiments alone, or embodiments combining the software and hardware aspects. Also the disclosure can take the form of computer program products implemented on one or more computer usable storage mediums (including but not limited to magnetic disk memories, optical memories and the like) containing computer usable program codes therein.

The disclosure is described by reference to the flow charts and/or the block diagrams of the methods, the devices (systems) and the computer program products according to the embodiments of the disclosure. It should be understood that each process and/or block in the flow charts and/or the block diagrams, and a combination of processes and/or blocks in the flow charts and/or the block diagrams can be implemented by the computer program instructions. These computer program instructions can be provided to a general-purpose computer, a dedicated computer, an embedded processor, or a processor of another programmable data processing device to produce a machine, so that an apparatus for implementing the functions specified in one or more processes of the flow charts and/or one or more blocks of the block diagrams is produced by the instructions executed by the computer or the processor of another programmable data processing device.

These computer program instructions can also be stored in a computer readable memory which is capable of guiding the computer or another programmable data processing device to operate in a particular way, so that the instructions stored in the computer readable memory produce a manufacture including the instruction apparatus which implements the functions specified in one or more processes of the flow charts and/or one or more blocks of the block diagrams.

These computer program instructions can also be loaded onto the computer or another programmable data processing device, so that a series of operation steps are performed on the computer or another programmable device to produce the computer-implemented processing. Thus the instructions executed on the computer or another programmable device provide steps for implementing the functions specified in one or more processes of the flow charts and/or one or more blocks of the block diagrams.

Evidently those skilled in the art can make various modifications and variations to the application without departing from the spirit and scope of the application. Thus the application is also intended to encompass these modifications and variations therein as long as these modifications and variations come into the scope of the claims of the application and their equivalents.

What is claimed is:

1. A method for generating a speech recognition model, wherein the speech recognition model comprises an encoder and a decoder, and the method comprises:
obtaining training samples, wherein each of the training samples comprises a speech frame sequence and a corresponding labeled text sequence;
training the encoder by using the speech frame sequence as an input feature of the encoder and using speech encoded frames of the speech frame sequence as an output feature of the encoder;
training the decoder by using the speech encoded frames as a first input feature of the decoder and using the labeled text sequence as a first output feature of the decoder, and obtaining a current prediction text sequence; and
training the decoder again by using the speech encoded frames as a second input feature of the decoder and using a sequence as a second output feature of the decoder, wherein the sequence is obtained by sampling the labeled text sequence and the current prediction text sequence based on a preset probability.

2. The method of claim 1, wherein said obtaining training samples comprises:
obtaining a speech signal;
obtaining an initial speech frame sequence by extracting speech features from the speech signal;
obtaining spliced speech frames by splicing speech frames in the initial speech frame sequence; and
obtaining the speech frame sequence by down-sampling the spliced speech frames.

3. The method of claim 1, wherein the preset probability is determined based on an accuracy of the current prediction text sequence output by the decoder.

4. The method of claim 3, wherein the preset probability is determined by:
determining the preset probability of sampling the current prediction text sequence in a direct proportion to the accuracy of the current prediction text sequence;
determining the preset probability of sampling the labeled text sequence in an inverse proportion to the accuracy of the current prediction text sequence.

5. The method of claim 1, further comprising:
terminating training the speech recognition model in response to that a proximity between the current prediction text sequence and the labeled text sequence satisfies a preset value and that a character error rate in the current prediction text sequence satisfies a preset value, wherein the labeled text sequence corresponds to the current prediction text sequence.

6. The method of claim 1, wherein the labeled text sequence is a labeled syllable sequence, and the prediction text sequence is a predicted syllable sequence.

7. A device for generating a speech recognition model, wherein the speech recognition model comprises an encoder and a decoder, and the device comprises:
a processor; and
a memory configured to store instructions executable by the processor;
wherein the processor is configured to execute the instructions to:
obtain training samples, wherein each of the training sample comprises a speech frame sequence and a corresponding labeled text sequence;
train the encoder by using the speech frame sequence as an input feature of the encoder and using speech encoded frames of the speech frame sequence as an output feature of the encoder; and
train the decoder by using the speech encoded frames as a first input feature of the decoder and using the labeled text sequence as a first output feature of the decoder, and obtain a current prediction text sequence;
train the decoder again by using the speech encoded frame as a second input feature of the decoder and using a sequence based on a preset probability as a second output feature of the decoder, wherein the sequence is obtained by sampling the labeled text sequence and the current prediction text sequence based on a preset probability.

8. The method of claim 7, wherein the processor configured to:
obtain a speech signal;
obtain an initial speech frame sequence by extracting speech features from the speech signal;
obtain spliced speech frames by splicing speech frames in the initial speech frame sequence; and
obtain the speech frame sequence by down-sampling the spliced speech frames.

9. The method of claim 7, wherein the preset probability is determined based on an accuracy of the current prediction text sequence output by the decoder.

10. The method of claim 9, wherein processor is configured to:
determine the preset probability of sampling the current prediction text sequence in a direct proportion to the accuracy of the current prediction text sequence output by the decoder, and determine the preset probability of sampling the labeled text sequence in an inverse proportion to the accuracy of the current prediction text sequence output by the decoder.

11. The method of claim 7, wherein the processor is further configured to:
terminate training the speech recognition model in response to that a proximity between the current prediction text sequence and the labeled text sequence satisfies a preset value and that a character error rate (CER) in the current prediction text sequence satisfies a preset value, wherein the labeled text sequence corresponds to the current prediction text sequence.

12. The method of claim 7, wherein the labeled text sequence is the labeled syllable sequence, and the prediction text sequence is a predicted syllable sequence.

13. A computer readable storage medium storing computer programs that, when executed by a processor, cause the processor to perform the operation of:
obtaining training samples, wherein each of the training samples comprises a speech frame sequence and a corresponding labeled text sequence;
training an encoder by using the speech frame sequence as an input feature of the encoder and using speech encoded frames of the speech frame sequence as an output feature of the encoder;
training a decoder by using the speech encoded frames as a first input feature of the decoder and using the labeled text sequence as a first output feature of the decoder, and obtaining a current prediction text sequence; and
training the decoder again by using the speech encoded frames as a second feature of the decoder and using a sequence as a second output feature of the decoder, wherein the sequence is obtained by sampling the labeled text sequence and the current prediction text sequence based on a preset probability.
